(19) United States
(12) Patent Application Publication
(10) Pub. No.: US 2012/0197997 A1
(43) Pub. Date: Aug. 2, 2012

(54) Interest Management for a Virtual Environment of a Peer-to-Peer Network

(75) Inventors: Santosh Kulkarni, Glen Waverley (AU); Dave Churchill, Melbourne (AU); Scott Douglas, North Firzroy (AU)

(73) Assignee: NATIONAL ICT AUSTRALIA LIMITED, Eveleigh, NSW (AU)

(21) Appl. No.: 13/381,346

(22) PCT Filed: Jul. 14, 2010
(86) PCT No.: PCT/AU2010/000898

§ 371 Date: Jan. 31, 2012

(30) Foreign Application Priority Data
Jul. 14, 2009 (AU) 2009903300

(51) Int. Cl. G06F 15/16

(52) U.S. Cl. 709/204

(57) ABSTRACT

The present invention relates to the provision of interest management in peer-to-peer networks that provide a virtual environment for multiple users. One example of such an environment is an online gaming environment. The invention includes a switching algorithm (FIG. 9) that efficiently switches (902) the interest management provided by a peer to an entity between three protocols (cell, interest bounded and gossip) in response to the processing load on the relevant peer. This makes the interest management service scalable and reliable. The gossip protocol (FIG. 8) sends interest management information to the neighbours of the an entity, and also reduces the frequency of sending requests for interest management information to an interest management service for that entity.

### CROSS-REFERENCE TO RELATED APPLICATIONS

The present application claims priority from Australian provisional patent application No. 2009903300 filed 14 Jul. 2010 the content of which is incorporated herein by reference.

Further, the content of PCT patent application No. PCT/AU2009/001331 filed on 8 Oct. 2009 (publication No. WO 2010/04179) is also incorporated herein by reference.

### TECHNICAL FIELD

The present invention relates to the provision of interest management in peer-to-peer networks that provide a virtual environment for multiple users. One example of such an environment is an online gaming environment. Aspects of the invention include methods of facilitating interest management, software, computer systems, development platform and a peer-to-peer network.

### BACKGROUND ART

A peer-to-peer network is any distributed computer network architecture composed of nodes that are each typically a computer system (i.e. processing hardware). Peer-to-peer networks are commonly used in file-sharing applications and can be used to provide a decentralised multi-user virtual environment since the distributed architecture provides enhanced scalability and service robustness.

Peer-to-peer networks are typically formed dynamically by ad-hoc additions of nodes and in turn peers, where a peer is an instance of the software application of the virtual environment running on a node. Typically there would be one peer per node but multiple instances of the software (i.e. peer) may be run on a node.

Interest management in a virtual environment enables sharing relevant spatial information. Interest management is provided by peers to their allocated set of entities using an interest management service of the network. That is, each entity in the virtual environment has an interest region which is usually an area that can be defined in the virtual environment and is centred on that entity. Entities only require information about other entities with which they share a region of interest. By doing so, network bandwidth consumption is greatly reduced when compared to global information sharing within the networked virtual environment. Also, the workload of each peer facilitating the interest management is also alleviated.

While interest management is straightforward in the client-server model network, it provides additional challenges in a peer-to-peer network.

In structured peer-to-peer networks, interest management can be supported using a distributed hash table-based (DHT) indexing. Using DHT, the virtual environment is divided into fixed cells. An authoritative node is dynamically assigned to each cell and is responsible for coordinating interest information between entity members of the cell by maintaining a cache of the information.

An example of a resource intensive peer-to-peer network includes multi-user online gaining environments. Online gaming environments increasingly involve complex and large virtual environment, where there are a large number of users participating in real-time. Interest management in an online gaming platform concerns ensuring that the game state of entities are accurate and updated. An entity can be any object within the virtual environment, such as avatars (users), non-playing characters such as monsters, and dynamic content such as light-switch or a moving car.

Interest regions are typically larger than what is visible by the entity. For example an avatar entity will have an interest region slightly lager than the actual visible region on their screen. Entities that represent dynamic content and have visible regions will have an interest region that is a sphere with a radius of zero units.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

In a first aspect, the invention provides a method performed by a peer for facilitating interest management for a virtual environment of a peer-to-peer network comprising:
(a) performing interest management for entities within the virtual environment, including sending requests for interest management information on behalf of the entities; and
(b) based on a processing load for performing interest management by the peer satisfying a criteria, selectively performing interest management by:
   (i) allocating the facilitating of interest management for a subset of the entities to a further peer, or
   (ii) reducing the frequency of sending the requests for interest management information.

It is an advantage of the invention that changes in the method for facilitating interest management over time can be made efficiently and in response to changes in the processing load of the peer to make the interest management service scalable and reliable.

Interest management information may include discovery information, that is information introducing new entities to the entities the peer performs interest management for.

An entity can be any object in the virtual environment, including users and dynamic content.

Step (a) is performed for those entities that are allocated to the peer to facilitate interest management for.

The virtual environment may be an online gaming environment, such as a massively multiplayer online game (MMOG).

Performing interest management in step (a) may comprise sending requests for interest management information to an interest management service, such as a distributed hash table (DHT). This method will provide a significant reduction in the traffic overheads associated with the DHT (Distributed Hash Table). This reduces the load on the DHT and can improve the overall performance of the system significantly.

The method may further comprise, in the case of (i) and based on the processing load for performing interest management by the peer again satisfying the criteria, allocating interest management for a further subset of the entities to a yet a further peer.

Step (b) is further based on whether the current interest management method of step (a) is based on sending requests to an information management service, and/or is the result of a previous selection of either (i) or (ii).

In the case of (i), the subset of entities for which the further peer facilitates interest management may change over time.

The processing load criteria may be based on one or more of:
number of entities that the peer facilitates interest management for;
number of intersections a particular entity has;
processing capacity of the peer, including upstream and downstream bandwidth for interest management communications;
candidate groupings of the entities that the peer facilitates interest management for based on areas of interest of the entities; and
estimated proportion of entities that the peer facilitates interest management for.

The processing load criteria may be specific to the particular application of the virtual network.

The case of (ii) is may be in accordance with the fourth aspect of the invention described below.

The method may be performed by the peer for each entity that is allocated to the peer to facilitate interest management for.

In a second aspect the invention provides software, that when executed causes a peer of a virtual environment of a peer-to-peer networked virtual environment to facilitate interest management according to the first aspect of the invention.

In a third aspect the invention provides a computer system hosting a peer of a virtual environment of a peer-to-peer networked virtual environment operable to facilitate interest management, comprising a communications port, storage means and a processor to perform the method according to the first aspect of the invention.

In a fourth aspect the invention provides a method for facilitating interest management for a first entity in a virtual environment of a peer-to-peer network comprising:
(a) sending interest management information to the neighbours of the first entity; and
(b) reducing the frequency of sending requests for interest management information to an interest management service.

The method is performed by the peer on behalf of an entity allocated to it to facilitate interest management for. The method may be performed by the peer for each entity allocated to it to facilitate interest management for.

The interest management information may be presence information, such as an introduction.

The frequency of step (b) may be reduced by ensuring that the frequency does not exceed a threshold.

The frequency of step (b) may based on the capacity of the interest management service, such as the cell server capacity of the appropriate distributed hash table (DHT).

The frequency of step (b) may comprise initially determining a proportion of the estimated number of intersections of the first entity to a threshold. Step (b) may comprise generating a random number and only sending the request if the random number indicates that the request should be sent. The comparison may be of the random number and the proportion.

Step (a) may be performed at a further higher frequency than the frequency of step (b),

Step (a) is performed at a frequency that may be based on an amount of bandwidth that is allocated by the peer to perform step (a).

Neighbours of the first entity may include the entities that the first entity currently exchanges update status messages with and/or entities that the peer also facilitates interest management for.

The requests of step (b) may be sent to an interest management service, such as a distributed hash table (DHT) that supports the virtual environment.

Step (a) may comprise including the interest management information in entity update messages that are sent relating to the first entity, such as real time state synchronisation messages.

In a fifth aspect the invention provides software, that when executed causes a peer of a virtual environment of a peer-to-peer network to facilitate interest management according to the fourth aspect of the invention.

In a sixth aspect the invention provides a computer system hosting a peer of a virtual environment of a peer-to-peer network operable to facilitate interest management, comprising a communications port, storage means and a processor to perform the method of the fourth aspect of the invention.

In a seventh aspect the invention provides a development platform software application enabling game developers to design multi-player online games in which interest management is facilitated according to the method of the first and/or third aspect of the invention.

In an eighth aspect the invention provides a peer-to-peer network hosting a virtual environment, wherein interest management in the virtual environment is facilitated according to the method of the first and/or third aspect of the invention.

### BRIEF DESCRIPTION OF THE DRAWINGS

Example(s) of the invention will now be described with reference to the accompanying drawings in which:

FIG. 1 is a schematic diagram of the network engine of this example.

FIG. 2 is a schematic diagram of the peer-to-peer network implementing the Cell protocol.

FIG. 3 is a schematic diagram of the peer-to-peer network implementing the Cell protocol and with an overloaded cell node (server).

FIG. 4 is a schematic diagram of the peer-to-peer network that includes an implementation of the Dynamic bounded protocol.

FIG. 5 schematically shows the merging operation of two bounded regions.

FIG. 6 schematically shows the splitting operation of a bounded region.

FIG. 7 schematically shows two subgroups of entities of a bounded region.

FIG. 8 is a flow diagram of the method of the gossip protocol.

FIG. 9 is a flow diagram of the method of the switching algorithm between the protocols.

FIG. 10 is a schematic diagram of the components of a computer system that hosts a peer able to perform the methods of FIGS. 7 and/or 8.

### BEST MODES

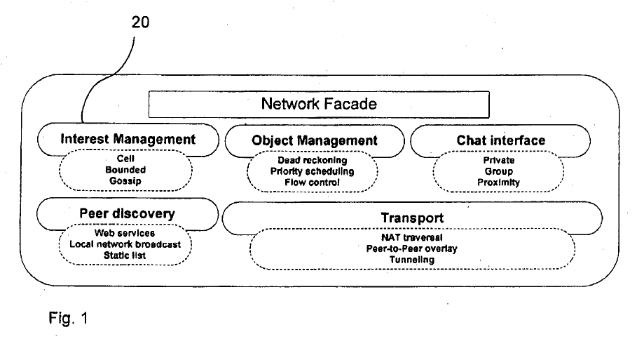

In this example the virtual environment is that of a massively multiplayer online game (MMOG). The example uses an engine designed for virtual environments that provides a complete networking framework. It includes a network Plug-in that interfaces with existing massively multiplayer online (MMO) to make the network highly scalable. A schematic representation of the logical components of this engine is shown in FIG. 1. The example here is specific to the interest management service 20 of the network engine. The interest management service is responsible for providing relevant real-time information to all entities in the MMO application and ensuring that their game state is accurate and updated. The interest management service treats all objects within the virtual environment as entities.

In the absence of a centralised indexing server, the engine relies on distributed spatial indexing algorithms that can be executed on the peer-to-peer network by the peers. In this example, the peers responsible for interest management utilise a tiered approach that switches automatically between three different protocols depending on the network conditions in the virtual environment.

In this example the three interest management protocols are:
Cell
Dynamic bounded region, an
Gossip.

Each protocol will now be described in turn.

### Cell Protocol

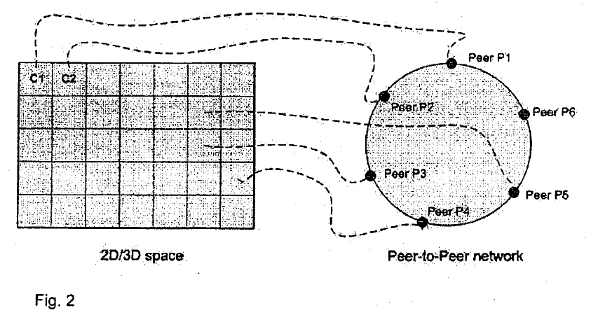

The virtual environment is divided into fixed sized regions (cells) and inserts these cells on the peer-to-peer network that is formed by a distributed hash table (DHT). The mapping ensures that there is adequate load balancing across all the peers in the network. The size of each cell is dependent on the number of peers in the network and also on the nature of the application. The peer that is nearest/closest to the mapped cell becomes responsible for that cell. That is the node hosting that peer is considered the cell node (server). For example, in FIG. 2, P1 is the cell node (server) for cell C1 and P2 is the cell node (server) for cell C2.

When a peer introduces/announces its allocated entity to the network, it uses the cell protocol to insert the entity and its interest region into the virtual environment. The appropriate cell server gets a notification of the new entity (request) and in return informs the introducing peer about other relevant entities in the new entities interest region.

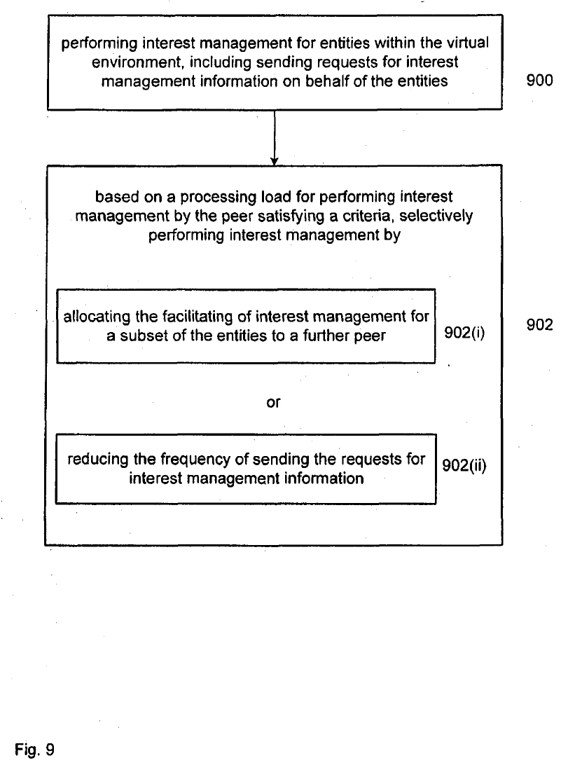

The cell server also updates all other entities in cell (via the respective peer) about this new entity if the new entity intersects the other entities' interest region. Via the peer, entities within a cell periodically query the relevant cell node (server) to find out about other entities in their interest region, known as requests for interest management information (see 900 of FIG. 9). The cell server responds with an updated set of intersections with other entities and interest regions. The cell node (server) only sends the changes in the intersection set and not the entire intersection set.

As the number of intersections for a given entity increases, for example increase in the avatar density for a certain space in the virtual environment, the interest management algorithm performed switches to dynamic bounded approach as described below.

### Dynamic Bounded Region Protocol

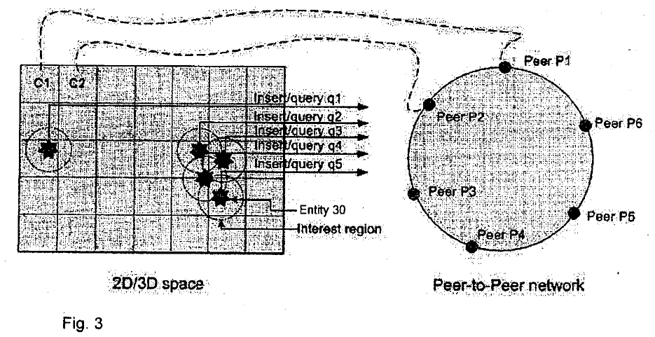

One of the drawbacks of using the cell protocol is in the large overhead involved in maintaining the DHT. Every single insert in the DHT is replicated several times (depending on the size of the DHT). Therefore, if there are a large number of entities in a virtual environment, they would introduce a significant load on the DHT making it unstable. FIG. 3 shows an example of how multiple entities (one indicated at 30) can cluster together in a virtual space to overload the DHT. Dynamic bounded region protocol addresses this issue by reducing the load on the DHT and ensuring that it remains stable even if the number of entities in the virtual environment increase significantly. A full description of the Dynamic bounded region protocol can be found in PCT patent application No. PCT/AU2009/001331 filed on 8 Oct. 2009 (publication No. WO 2010/04179).

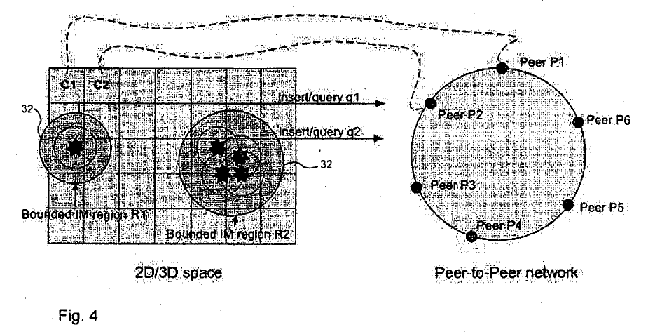

Referring now to FIG. 4, a dynamic bounded interest management (IM) region 32 is a region in space that can be of any shape and size. Unlike a cell, a bounded IM region is dynamic—it can move around in the virtual space and resize itself as required. Furthermore, a bounded IM region is itself an “entity”, so it can be inserted into other interest management services (e.g. Cells or other bounded IM regions). A bounded IM region can take on any shape, such as a sphere, supported by the underlying object system.

Dynamic bounded IM regions introduce an additional level in the discovery process. Interest management of each entity and its associated interest region is provided by a bounded IM region. The bounded region, via its bounded region managing peer, queries the DHT to find out about other entities and other bounded regions of interest. The entities in the interest region query their bounded region to identify any entities of interest.

The bounded region is controlled by a managing peer. The bounded region manager's task for a particular bounded region is assigned to a peer on the network. The peer selection is made in such a way that the load is distributed across the network. When there is only one entity in the bounded region, the bounded region is managed by the local peer (the peer that is allocated that entity). This eliminates the communication overheads associated between the entity and the bounded region.

Operation of the system begins with the bounded region managing peer creating a bounded region and inserting the entities and their interest region in the bounded region (see 902(i) of FIG. 9). The bounded region managing peer then inserts the bounded IM region into the DHT using the cell protocol. Cells will detect intersections between the inserted bounded IM region and the existing entities in the space, and notify these entities via the responsible peer, of the new service. In turn, these entities will remove their regions from the cells and insert them into the bounded IM region. If an entity is fully contained by the bounded IM region, the region managing peer of the bounded IM service will send a notification to the entity informing that the entity has separated from the DHT. The net effect is that only one region is inserted into the DHT covering all the entities, significantly reducing traffic associated with DHT replication.

Entities are free to enter or leave areas of space covered by bounded IM regions at any time. The interest management services will inform them of intersections/separations with bounded IM regions and the DHT, and IM subscriptions can then be updated as required. Equally, bounded regions can move or resize as required to minimize network traffic and the interest management notifications will still ensure consistency of IM subscriptions.

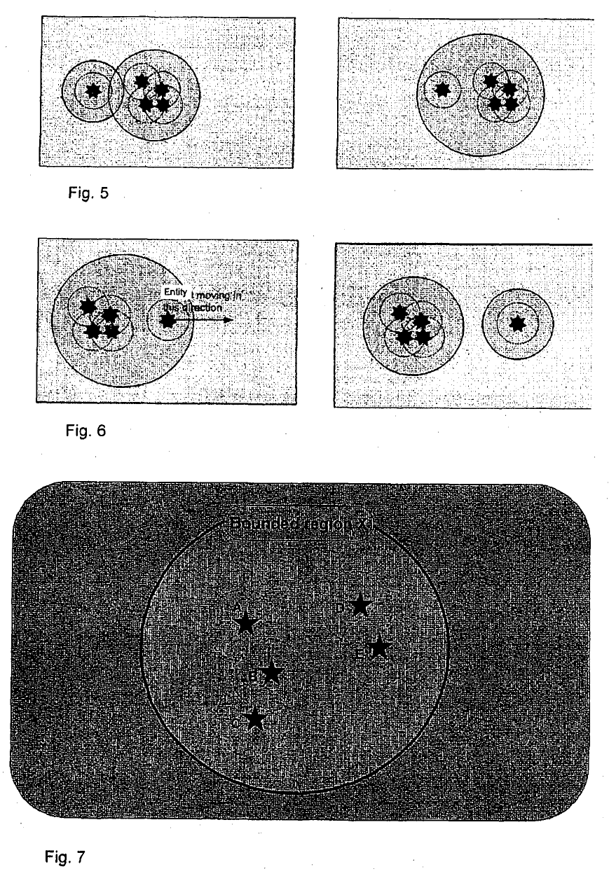

Bounded IM regions have a default size. However, they can grow and shrink in size to accommodate multiple objects. There is a maximum size limit that is calculated in order to optimize system performance. Bounded regions can merge (see FIG. 5) with other regions or they can split (see FIG. 6) into multiple bounded regions depending on the movement of the entities within the region.

The behaviour of bounded regions can be described by the following algorithms. Let us assume that there is a bounded region B, that contains N entities O₁, O₂, . . . , O_{N}. Every time an entity moves out of its subscription region, its responsible peer will send a request to the bounded region and the managing peer of the bounded region, in turn calls the Modify_Region( ) function. To understand the algorithms we introduce the concept of sub-groups. Entities within a region are categorised into sub-groups depending on the overlap of their interest regions. All entities within a sub-group have some degree of overlap or are connected via another entities. For example, in FIG. 7, bounded region X has two sub-groups. The first group is comprised of A, B and C, and the second subgroup is comprised of D and E. Even though the interest region for entities A and C do not intersect each other, they are part of the same sub-group as they are connected via entity B.

The algorithm for Modify_Region( ) Merge( ) and Split( ) are as follows:

Modify_Region (Region B)
{
Overlap region list L:= { }
for each R in L do

Calculate overlap between B and R;
if (overlap > 50%)

Merge (B, R);

Entity list X:= { }
Parse each E in X and form sub-groups;
Resize B so that it encloses all the entities in X;
for the largest sub-group g

Split (B, g);

}
Merge (Region B, Region C)
{
Increase the size of B until it encloses C;
Shutdown C;
Transfer all entities from C to B;
}
Split (Region B, Subgroup g)
{
Create new region C;
Entity list for sub-group g is X:={ }
Entity list for region B is Y:={ }
for each entity E in X do
Transfer E from region B to region C;
Reduce the size of B to enclose all entities in Y;
}

Bounded IM regions can fail or lose connectivity (temporarily or permanently) with the various entities in its region or the DHT. When this happens, all the entities and the bounded IM regions revert to using the cell protocol and new bounded IM regions will be formed from scratch. This provides a fall back mechanism for interest management in the event of a bounded IM region failure, ensuring that bounded IM regions can recover from network and device failures in a smooth manner without loss of connectivity.

### Gossip Protocol

Bounded interest management reduces the load on the DHT and hence the subsequent overheads attached in replication. However, bounded regions have a limit in terms of the number of entities they can support. Since bounded region are managed by individual peers they could get overloaded if a large number of entities joined the bounded IM region. This situation could occur if a large number of users clustered in a small space. As shown in FIG. 3, all the entities would be part of the same bounded region. This would result in overloading the managing peer for that bounded region and make the system unstable. Gossip protocol ensures that peers don't get overloaded no matter how many entities enter a bounded region or a cell.

A peer provides for an entity interest management using gossip mode when the number of intersections for that entity exceeds a certain threshold (see 902 of FIG. 9). This threshold for entering gossip mode is proportional to the total number of entities in the entity's region of interest.

Each entity, via the responsible peer, always inserts itself into the DHT (using the Cell protocol) the first time it enters the virtual environment. However, as the number of intersections for the entity exceeds the predetermined threshold (see 902 of FIG. 9), the responsible peer for that entity switches to the gossip protocol to facilitate interest management for that entity.

### Limiting Requests to the DHT

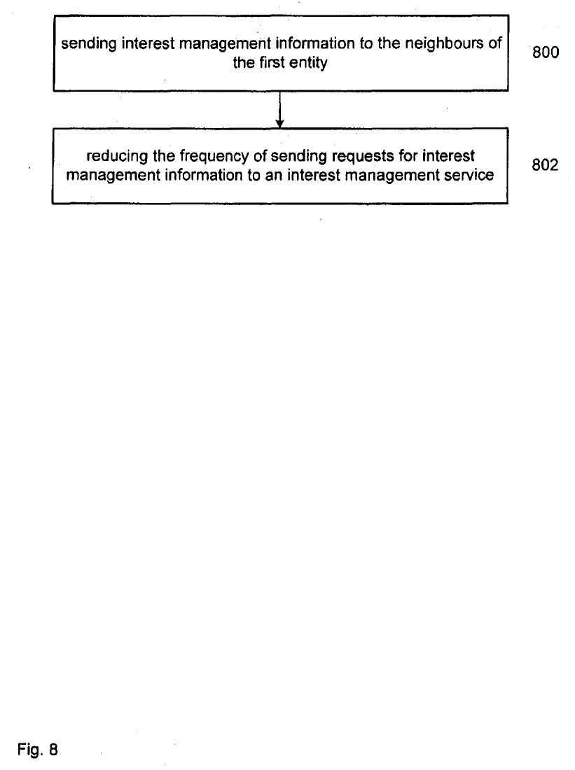

Gossip protocol ensures that the interest management service can scale to a large number of users (and in turn entities) without degrading the performance of the overall system. This is achieved by the responsible peer, for that entity by reducing the frequency of interest management queries the that are made the appropriate cell server on behalf of the entity (see 802 of FIGS. 8 and 902(ii) of FIG. 9). This reduced frequency may be based on a threshold that is pre-defined and programmable. For example, the reduced frequency of queries is determined by or provided to the responsible peer based on the appropriate cell server's capacity. The reduced frequency may also depend on other parameters such as the entities region density and number of intersections for that peer.

While an entity is managed in gossip mode, by reducing rather than stopping the querying of the interest management service, this ensures that the cell server has knowledge of the entities and can rectify any discrepancies.

The frequency at which the DHT is queried for an entity ei is computed using a probability function that takes into account the number of intersections for that entity.

Let us assume that the threshold for an entity to enter gossip mode is T intersections (there are more than T entities in the area of interest for ei).

For a given time period P, let the number of known intersections for ei be K (which must be larger than T as otherwise ei would not be in gossip mode). Let us assume that the peer responsible for ei receives R introductions while gossiping with its neighbours during this time period P. Out of total R introduced entities a sub-set of entities U were not previously known to the responsible peer (that is some of the gossip information received may relate to entities already known to the entity). An estimate of the total number of entities Ni in the interest region of ei is computed since the peer has not communicated with the cell server for some time and does not know exactly. Ni is calculated as follows:

Ni=(U/R)*K+K

Note that estimated Ni is always more or equal to K which is more than T.

The gossip frequency is computed using a probability functions (PDF) ρᵢ as follows:

ρᵢ=T/Ni

Note that ρᵢ is always 1 or less since Ni is always more than T.

Every time the responsible peer for ei is due to query the DHT, it generates a random number between 0 and 1. If the random number is less than ρi, the peer queries the DHT, otherwise it does not. That is, the frequency is based on the degree that Ni is more than the threshold T and the generated random numbers.

This procedure ensures that the total number of queries made to the cell server never exceeds the threshold T in that time period.

### Gossip Messages Between Entities

Instead, entities via their responsible peers rely on neighbouring entities to inform each other about other entities in the virtual space (see 800 of FIG. 8).

Typically each peer knows several regions and information of these regions are stored in their local memory. When facilitating interest management for an entity in gossip mode, the responsible peer for that entity sends information regarding such known regions to other peers of entities, that is, peers exchange region details with other peers (see 800 of FIG. 8).

For example, assume there are four Peers A, B and C that control entity A, B and C respectively. The three entities A, B and C have a region A, B and C respectively.

A and B are neighbours in that Entity A (via Peer A) knows the region B, for example a cell server may have given Peer A the details of region B or alternatively the information may be obtained from a bounded IM system as entity A and B are within each other's area of interest. B and C are neighbours in that entity C knows the region B.

Periodically entities A and B, and entities B and C (via their peers) exchange entity updates, such as position information.

Entity A is now being managed in gossip protocol by peer A and interest information is added to some entity update messages entity A periodically sends to entities B and C (see 802 of FIG. 8). The interest information is “gossip” in the sense that A will inform entity B about the presence of entity C. Entity A will also inform entity C of the presence of entity B.

Entity B (via peer B) receives message update packets from A and processes it in the usual way. If B detects the additional “gossip” information in the message it will process this information as follows. If B is already aware of entity C it will simply ignore the additional information in the update message. If entity B is not aware of entity C being the entity B's area of interest this is considered an introduction. Then entity B will attempt to communicate with entity C (via their respective peers) to share update messages in future.

When peer A switches entity A to gossip protocol, a fixed amount of bandwidth is allocated for gossip. This bandwidth is used by the peer A to introduce other entities while gossiping/interacting with its neighbours. Peer A ensures that the bandwidth is not exceeded by only sending the interest information on some randomly selected update messages.

Gossip protocol ensures that the interest management service is robust and stable and can support densely crowded regions without overloading the peer-to-peer network.

### Selectively Switching Between

The method of selectively switching between interest management protocols performed by a peer in the structured peer-to-peer network will now be described.

An example selective switching algorithm is shown below where:

P Peer capacity (int x, int y)

The peer's capacity is the peer's estimated bandwidth reserved for interest management.

x is the estimated upstream, bandwidth and y is the estimated downstream bandwidth for interest management.
n The integer number of intersections

This is the number of intersections the for an entity. That is, n represents the estimated number of entities in the entities region of interest.

G Global state level (float)

This is the estimated ratio of the estimated number of entities in the entities region of interest to the total number of entities in the network N.

In a structured peer-to-peer network, each peer has local knowledge of the network therefore the total number of peers in the network is not known to each peer. Instead in this example the peer estimates the total number of peers in the network as follows. Each peer is responsible for a certain region in the space. For example, if there is only one peer in the network it is responsible for the entire virtual space (see FIG. 7). If there were three peers in the network, each peer on average would be responsible for a third of the virtual space since the hash function of is random enough to assume that overall the peers are evenly distributed. This is schematically shown in FIG. 8. Therefore if there are N peers in the virtual network, then on average each peer would be responsible for 1/N^{th} of the entire virtual space. Each peer uses this method to estimate the value of N.

The following algorithm is performed by the peer for each of its allocated entities each entity may be interest managed using a different protocol.

Select_Protocol (P Peer capacity, n No. of intersections, G Global State
Level)
{
Constant t =f(P.x, P.y)
Constant U = f(P.x)
Entity List X:{ }
Parse each E in X and form subgroups;
Let s = No. of sub-groups
If (protocol = Cell) && (s > t)

Switch_Protocol (Bounded region);

If (protocol = Cell or Bounded Region) && (n > U)

Switch_Protocol (Gossip);

If (G > 0.5)

Switch_Protocol (Cell);

If (G <= 0.5) and (n < U)

Switch_Protocol (Bounded Region);

If (G <= 0.5) and (n > U)

Switch_Protocol (Gossip);

}

That is:

Constant t=f(P·x, P·y)

The peer calculates the threshold t based on the P peer capacity.

Constant U=f(P·x)

The peer calculates the threshold U based on the peer P capacity

### Entity List X:{ }

Generate a list of all the entities that the peer P provides interest management to.

Parse each E in X and form subgroups

That is, entities allocated to the peer are categorised into sub-groups depending on their their interest regions.

Let s=No. of sub-groups

The parameter s is set to the number of subgroups identified above.

If (protocol=Cell) && (s>t)
Switch_Protocol (Bounded region)

If the peer P is currently operating the cell protocol for this entity and the number of subgroups is larger than the determined threshold t that is based on P's capacity, then the peer P is now set to operate according to the Bonded Region protocol described above in relation to this entity.

If (protocol=Cell or Bounded Region) && (n>U)
Switch_Protocol (Gossip)

If the peer P is currently operating either the Cell or Bounded Region protocols for this entity and the number of peers that fall within the entity's region is larger than a threshold U that is based on the peer P's downstream bandwidth for interest management, then the peer P is now set to manage the entity according to the Gossip protocol described above.

### If (G>0.5)

Switch_Protocol (Cell)

The load balancing threshold 0.5 is given here as a predetermined threshold. This threshold is tunable and varies depending on the application. In other implementations, a variable could be used to define this threshold parameter that could then be made an application-specific threshold value.

In this example if the peer P is responsible for less that an estimated 50% of the entities in the peer-to-peer network, then the peer P is now set to operate according to the Cell protocol described above.

If (G<=0.5) and (n<U)
Switch_Protocol (Bounded Region)

In this example if the peer P is responsible for more than an estimated 50% of the entities in the peer-to-peer network, and the number of intersections for that entity is larger than a threshold that is based on the peer P's downstream bandwidth for interest management, then the peer P is now set to operate according to the Bonded Region protocol described above.

If (G<=0.5) and (n>U)
Switch_Protocol (Gossip)

In this example if the peer P is responsible for more than an estimated 50% of the entities in the peer-to-peer network, and the number intersections for that entity is larger than a threshold that is based on the peer P's downstream bandwidth for interest management, then the peer P is now set to operate according to the Gossip protocol described above.

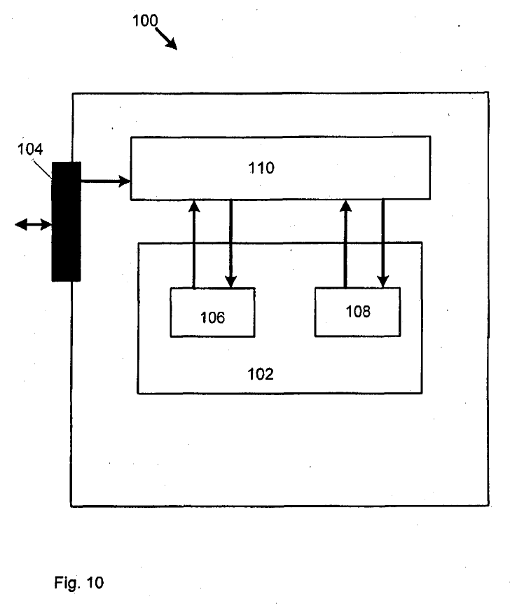

FIG. 10 shows schematically a computer system 100 that hosts the peer that is able to perform the switching algorithm and interest management protocols described above. The computer system includes memory 102 that includes storage for application software, which in this application includes the software to allow the user to participate on the virtual environment, and in particular software to implement a peer. Storage is also provided that stores amongst other things, information relating to information interest management. For example, details of the region of the entities allocated to the peer. A processor 110 is also provided to execute the software 108 and to access the information stored in 106 in order to perform the methods described above. The requests and update messages generated by the processor 110 are sent onto the network using the I/O port 104. Replies to the requests and update messages etc are received at the port 104 and are processed by the processor 110 as described above, which may comprise storing some information in the memory 106.

In other embodiments, different processing load measures of the peer P and threshold criteria can be applied, and in a different sequence in order to efficiently switch between the three interest management protocols described.

Further interest management protocols could be introduced, such a that a selection between four or more interest management protocols is made.

It is an advantage of this example that the interest management service is scalable so that it can handle flash crowds and at the same time is also reliable and accurate.

It will be appreciated by persons skilled in the art that numerous variations and/or modifications may be made to the invention as shown in the specific embodiments without departing from the scope of the invention as broadly described.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “constructing” or “processing” or “receiving” or “accessing” or “including” or “computing” or “executing” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments are, therefore, to be considered in all respects as illustrative and not restrictive.

1. A method performed by a peer for facilitating interest management for a virtual environment of a peer-to-peer network comprising:
(a) performing interest management for entities within the virtual environment, including sending requests for interest management information on behalf of the entities; and
(b) based on a processing load for performing interest management by the peer satisfying a criteria, selectively performing interest management by:
(i) allocating the facilitating of interest management for a subset of the entities to a further peer, or
(ii) reducing the frequency of sending the requests for interest management information.

2. The method of claim 1, wherein performing interest management in step (a) comprises sending requests for interest management information to an interest management service.

3. The method of claim 1, wherein the method further comprises in the case of (i) and based on the processing load for performing interest management by the peer again satisfying the criteria, allocating interest management for a further subset of the entities to a yet a further peer.

4. The method of claim 1, wherein step (b) is further based on whether the current interest management method of step (a) is based on sending requests to an information management service, and/or is the result of a previous selection of either (i) or (ii).

5. The method of claim 1, wherein in the case of (i), the subset of entities for which the further peer facilitates interest management for changes over time.

6. The method of claim 1, wherein the processing load criteria is based on one or more of:
number of entities that the peer facilitates interest management for; number of intersections a particular entity has;
processing capacity of the peer;
candidate groupings of the entities that the peer facilitates interest management for based on areas of interest of the entities; and
estimated proportion of entities that the peer facilitates interest management for.

7. The method of claim 1, wherein in the case of (ii) for a first entity further comprises:
(a) sending interest management information to the neighbors of the first entity; and
(b) reducing the frequency of sending requests for interest management information to an interest management service.

8. The method of claim 1, wherein the method is performed by the peer for each entity that is allocated to the peer to facilitate interest management for.

9. Software, that when executed causes a peer of a virtual environment of a peer-to-peer networked virtual environment to facilitate interest management according to claim 1.

10. A computer system hosting a peer of a virtual environment of a peer-to-peer networked virtual environment operable to facilitate interest management, comprising a communications port, storage means and a processor to perform the method of claim 1.

11. A method for facilitating interest management for a first entity in a virtual environment of a peer-to-peer network comprising:
(a) sending interest management information to the neighbors of the first entity; and
(b) reducing the frequency of sending requests for interest management information to an interest management, service.

12. The method of claim 11, wherein the frequency of step (b) is reduced by ensuring that the frequency does not exceed a threshold.

13. The method of claim 11, wherein the frequency of step (b) is based on the capacity of the interest management service.

14. The method of claim 11, wherein the frequency of step (b) comprises initially determining a proportion of the estimated number of intersections of the first entity to a threshold.

15. The method of claim 11, wherein step (b) comprises generating a random number and only sending the request if the random number indicates that the request should be sent.

16. The method of claim 14, wherein step (b) comprises generating a random number and only sending the request if the random number indicates that the request should be sent and the comparison is of the random number and the proportion.

17. The method of claim 11, wherein step (a) is performed at a further higher frequency than the frequency of step (b).

18. The method of claim 11, wherein step (a) is performed at a frequency that is based on an amount of bandwidth that is allocated by the peer to perform step (a).

19. The method of claim 11, where the requests of step (b) are sent to an interest management service.

20. The method of claim 11, wherein step (a) comprises including the interest management information in entity update messages that are sent relating to the first entity.

21. Software, that when executed causes a peer of a virtual environment of a peer-to-peer network to facilitate interest management according to claim 11.

22. A computer system hosting a peer of a virtual environment of a peer-to-peer network operable to facilitate interest management, comprising a communications port, storage means and a processor to perform the method of claim 11.

23. A development platform software application enabling game developers to design multi-player online games in which interest management is facilitated according to the method of claim 1.

24. A peer-to-peer network hosting a virtual environment, wherein interest management in the virtual environment is facilitated according to the method of claim 1.

25. A development platform software application enabling game developers to design multi-player online games in which interest management is facilitated according to the method of claim 11.

26. A peer-to-peer network hosting a virtual environment, wherein interest management in the virtual environment is facilitated according to the method of claim 11.
